(19) United States
(12) Patent Application Publication
(10) Pub. No.: US 2001/0026062 A1
(43) Pub. Date: Oct. 4, 2001

(54) Protecting bag for the heads of automobile occupants

(76) Inventors: Noriyuki Kosugi, Tokyo (JP); Hiroshi Teramoto, Tokyo (JP)

Correspondence Address: Michael D. Kaminski, FOLEY & LARDNER, Washington Harbour, 3000 K. Street, N.W., Suite 500, Washington, DC, 20007-5109, US

(21) Appl. No.: 09/794,154

(22) Filed: Feb. 28, 2001

Related U.S. Application Data
(60) Provisional application No. 60/186,362, filed on Mar. 2, 2000.
(60) Provisional application No. 60/187,050, filed on Mar. 6, 2000.
(60) Provisional application No. 60/194,402, filed on Apr. 4, 2000.

(51) Int. Cl. B60R 21/22

(52) U.S. Cl. 280/730.2; 280/728.2

(57) ABSTRACT

A protecting bag for the heads of automobile occupants with each cell being inflatable simultaneously. A tubular body for supplying gas with openings and in intermediate portions thereof is arranged in an upper fringe of a protecting bag. Below the opening, a rear seat cell including numerous smaller cells is positioned. The smaller cells are radially arranged about the opening of the tubular body as a center at the same distance from the opening of the tubular body. Gas flows into each cell from the opening of the tubular body equally so that each cell inflates simultaneously.

### CROSS REFERENCE TO RELATED APPLICATIONS

The present application claims priority to and the benefit of the following U.S. Provisional Patent Applications:

Ser. No. 60/186,362 filed Mar. 2, 2000

Ser. No. 60/187,050 filed Mar. 6, 2000

Ser. No. 60/194,402 filed Apr. 4, 2000

The disclosure of each of the foregoing applications is incorporated by reference herein in its entirety.

### BACKGROUND

The present invention relates to a protecting bag for the heads of automobile occupants and, particularly, relates to a bag which is inflatable along windows of side doors, etc., in a side collision or during rolling over of an automobile. More particularly, it relates to a type of protecting bag for the heads of automobile occupants in which a plurality of cells are arranged in the longitudinal direction of the vehicle by combining two sheets together.

A protecting bag for the heads of automobile occupants of this type is disclosed in WO096/26087 and, is shown in FIGS. 1 and 9 thereof. The known bag comprises a duct member extending along the upper fringe of the bag from the end portion in the vehicle front side (the front end) to the end portion in the vehicle rear side (the rear end) and a number of cells linking with the duct member and extending downwardly. The protecting bag includes two facing sheets. The sheet in the side facing to occupants (the inside sheet) and the sheet in the side facing to the vehicle outside (the outside sheet) are joined together in the intermediate portions of the bag between the nearest cells.

In the bag according to WO096/26087, the duct member is formed by interweaving the inside sheet and the outside sheet so as to join them. Such a duct member is not necessarily suitable for feeding gas to the directing cells.

In Japanese Unexamined Patent Publication No. 2000-127886, the applicant discloses a protecting bag for the head of an automobile occupant capable of feeding gas to cells between sheets at just the right time. The protecting bag disclosed in the Publication is arranged in the vicinity of an intersecting corner line between the ceiling and a side wall in an automobile cabin, and is downwardly inflated along the side wall by introduced gas. A plurality of cells to be filled with gas are arranged between sheets in the longitudinal direction of an automobile by combining the inside sheet and the outside sheet together. A gas passage is arranged in the upper portion of the bag extending in the longitudinal direction of the vehicle. The gas passage is constructed in the form of a tubular body separate from the sheet and has plural gas openings in intermediate portions of the passage for supplying gas to each cell via the gas openings.

FIG. 5 is a front view showing a protecting bag 1 for the head of an automobile occupant according to an embodiment of the above-described Japanese Publication. FIGS. 6(a) to (i) includes sectional views at the lines VIa-VIa to VIi-VIi of FIG. 5, respectively; FIGS. 6(j) to (m) shows sectional views in the inflated states of the upper portions of (c), (d), (e), and (h) of FIG. 6, respectively; FIGS. 7 and 8 are sectional views at the lines VII-VII and VIII-VIII, respectively; and FIG. 9 is a perspective view of the tubular body.

As shown in FIG. 5, in the bag 1, cells 11 to 14 are formed between the inside sheet 2 and the outside sheet 3 by layering the sheets and stitching the sheets together along seams (4 to 9).

The seam 4 extends along the bottom fringe of the sheets 2 and 3 from the front end 1F to the rear end 1R of the bag 1. In addition, in the vicinity of the rear end 1R, the seam 4 is separated from the bottom fringe of the sheets 2 and 3 and extends upwardly in the form of a substantially U shape, thereby forming a slender cell 10 between the seams 4 and 5.

The seam 5 extends along the top fringe of the sheets 2 and 3 and is separated from the top fringe in the vicinity of the front end 1F of the bag so as to extend downwardly and to meet the seam 4.

The seam 6 extends vertically in the intermediate portions of the sheets 2 and 3. The seam 6 connects the sheets together in the vicinity of the longitudinally intermediate portion of the bag 1. The principal part of the seam 6 extends in the longitudinal direction along the vertically intermediate portion of the bag 1, and the both end portions of the seam 6 extend vertically so as to meet the seam 4. Cells 11 and 12 are separated from each other by the seam 6. However, the upper portion of the cell 11 communicates with that of the cell 12.

The seam 7 stitches the sheets 2 and 3 together in the vicinity of the center of the cell 11. The seam 7 prevents the distance between the sheets in the cell 11 from being excessively thick when the cell 11 is inflated.

The seams 8 and 9 extend vertically so as to separate cells 12, 13, and 14 from each other. The upper and lower portions of the cells 12, 13, and 14 communicate with each other, respectively.

A tubular body 20 is arranged so as to be sandwiched by the upper portions of the sheets 2 and 3. The tubular body 20 is arranged in the upper portion between the sheets 2 and 3 by rolling up a long belt-shaped sheet 20S so that the rolled up line faces downwardly. The tubular body 20 is formed by stitching the sheet 20S together with the sheets 2 and 3 by the seam 5.

The rear end 21 of the tubular body 20 extends to the rear end 1R of the bag 1 while the opened other end 24 extends an upper portion of the cell 13. In intermediate portions of the tubular body 20, an opening 22 facing the cell 11 and an opening 23 facing the cell 12 are formed. An inflator (not shown) is connected to the rear end 21

In addition, the nearer the opening of the tubular body 20 is to the inflator, the smaller the size of the opening becomes, enabling gas to be evenly supplied to each of the cells 11 to 14.

The sheets 2 and 3 and the sheet 20S forming the tubular body 20 include plural extending portions 30 protruding upwardly from the bag 1. A small hole 31 is formed in each extending portion 30. By inserting a bolt or rivet into each small hole 31, the bag 1 is fixed to an automobile body. In addition, the impact when the tubular body is inflated is directly transmitted to the vehicle body via the bolt or rivet and it is not transmitted by way of the sheets 2 and 3. Therefore, the required strength of the sheets 2 and 3 is relieved.

In the bag 1, the rear end 1R is arranged at a C pillar of an automobile while the front end 1F is arranged at an A pillar, for example. The bag 1 is folded and arranged along a roof-side rail. As described above, the rear end 21 of the tubular body 20 is connected to the inflator.

The folded bag 1 is covered with a cover. The cover is formed so as to tear or to be opened into the vehicle cabin when the bag 1 is inflated. The cover may be a cover used exclusive for the protecting bag apparatus or may be incorporated into the decorative trim in the automobile cabin.

When an automobile is in a collision or rolls over, the inflator is operated so that gas flows into the tubular body 20 from the rear end 21. Part of the gas flowing through the tubular body 20 flows out of the openings 22 and 23 so as to inflate the cells 11 and 12. The gas flowing out of the front end 24 of the tubular body 20 also inflates the cells 13 and 14. The inflated cell 11 extends toward the side of the head of an occupant in the rear seat and the inflated cells 12, 13, and 14 extend toward the side of the head of an occupant in the front seat.

The bag 1 comprises the tubular body 20 and is formed so that gas flows out of the openings 22 and 23 and the front end 24 of the tubular body 20, thereby the gas is supplied to each of the cells 11 to 14 by a predetermined route. Each of the cells 11 to 14 inflates substantially simultaneously.

In the protecting bag 1 for the head of an automobile occupant according to the above illustrated Japanese Unexamined Patent Publication No. 2000-127886, the gas from the inflator is introduced into the tubular body 20 via the rear end 21 of the tubular body 20, so that the cell 11 of the cells 11 to 14, which is nearer to the rear end 21, tends to inflate at an earlier time. To prevent this, the smaller the size of the opening is to be, the nearer the opening is to the rear end 21 in Japanese Unexamined Patent Publication No. 2000-127886. However, it is not easy to equalize the amount of the injected gas into plural numbers of cells via each of openings.

Accordingly, it is an object of the present invention to provide a protecting bag for the head of an automobile occupant, which is constructed so that each cell, into which gas is supplied via one opening, inflates at a time as the same as possible.

### SUMMARY OF THE INVENTION

In accordance with the present invention, a protecting bag for the heads of automobile occupants is provided. The bas is arranged in the vicinity of an intersecting corner line between a ceiling and a side wall in an automobile cabin and is downwardly inflated along the side wall by introduced gas. The protecting bag comprises: a plurality of cells to be filled with gas, which are arranged between sheets in the longitudinal direction of automobile by combining the inside sheet at the occupant side and the outside sheet opposite to the inside sheet together; a tubular gas passage arranged in an upper portion of the bag and extending in the longitudinal direction of the automobile; and a plurality of gas openings formed in the gas passage at intervals in the longitudinal direction of the gas passage, wherein gas flowing out of the gas openings is supplied to each of the plurality of cells, and wherein gas inlets of the plurality of cells are arranged at substantially the same distance from at least one of the plurality of gas openings.

In the protecting bag for the heads of automobile occupants according to the present invention, gas supplied into the tubular body flows out of gas openings in intermediate portions of the tubular body into plural cells so as to inflate them.

In the protecting bag for the heads of automobile occupants according to the present invention, gas inlets of the plurality of cells are arranged at substantially the same distance from one of the openings. Thereby, these plural cells are inflated substantially simultaneously by the gas flowing out of the one gas opening.

In this instance, plural cells are radially extended from one gas opening so that gas flows smoothly so as to inflate the cells quickly up to the end thereof.

According to the present invention, a protecting bag may further comprise a joining portion which joins the inside sheet and the outside sheet and which is arranged between the opening and the inlet of the cell, wherein the joining by the joining portion is released by gas injection from the opening. By this structure, at a moderate and suitable speed, gas can be supplied into each of plural cells from one opening.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a front view of a protecting bag 40 according to an embodiment.

FIG. 2 is a front view of a protecting bag 40A according to another embodiment.

FIG. 3 is a front view of a protecting bag 40B according to another embodiment.

FIG. 4(a) is a front view of a protecting bag 90 according to another embodiment before inflation;

FIG. 4(b) is a front view of the protecting bag 90 according to the embodiment after inflation.

FIG. 5 is a front view of a conventional protecting bag 1.

FIGS. 6(a) to (j) includes sectional views at the lines VIa-VIa to VIi-VIi of FIG. 5, respectively;

FIGS. 6(j), (k), (i), and (m) includes sectional views showing shapes of the inflated protecting bag 1.

FIG. 7 is a sectional view of the inflated protecting bag 1 at the line VII-VII of FIG. 5.

FIG. 8 is a sectional view of the inflated protecting bag 1 at the line VIII-VIII of FIG. 5.

FIG. 9 is a perspective view of a tubular body shown in FIG. 5.

### DETAILED DESCRIPTION

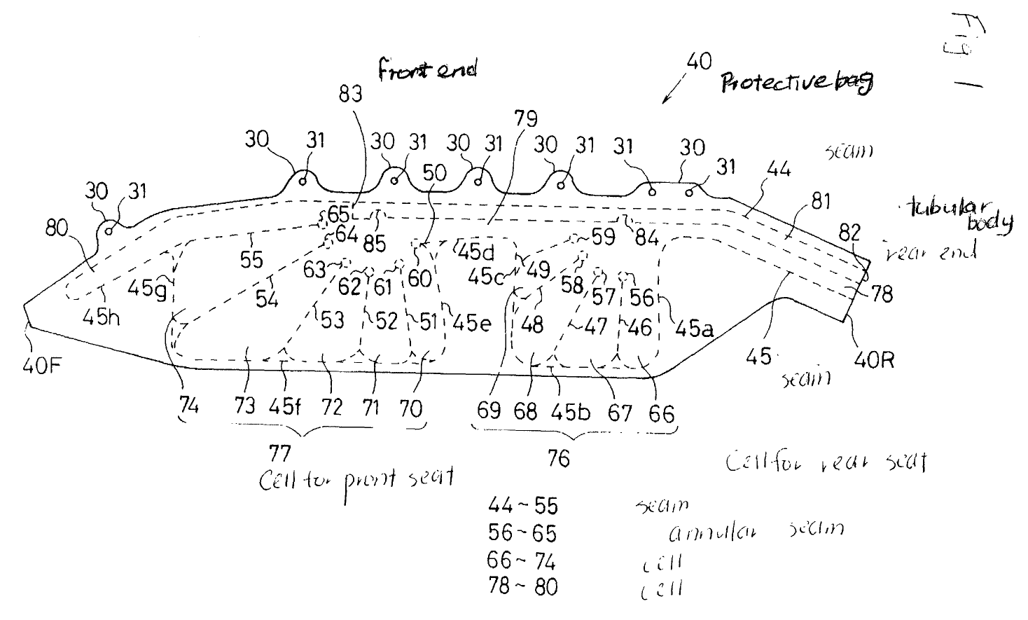

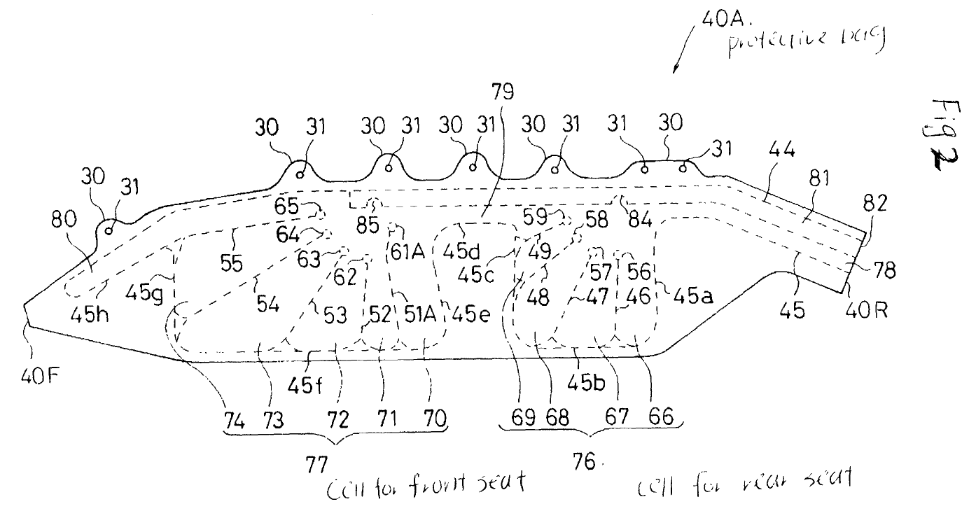

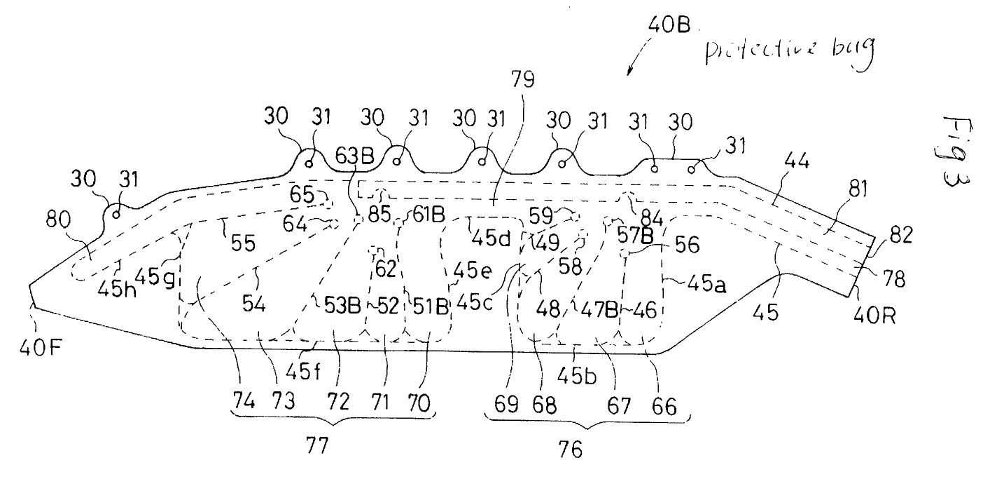

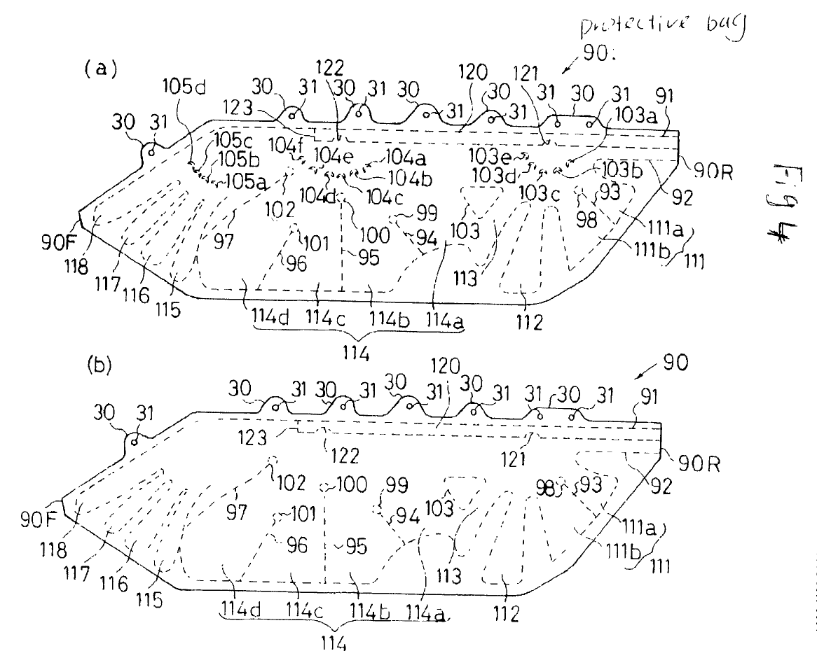

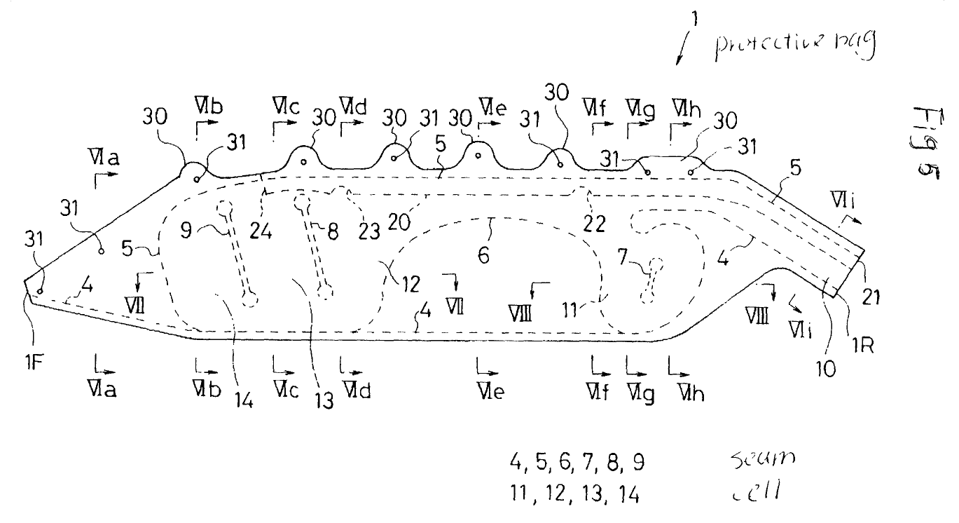

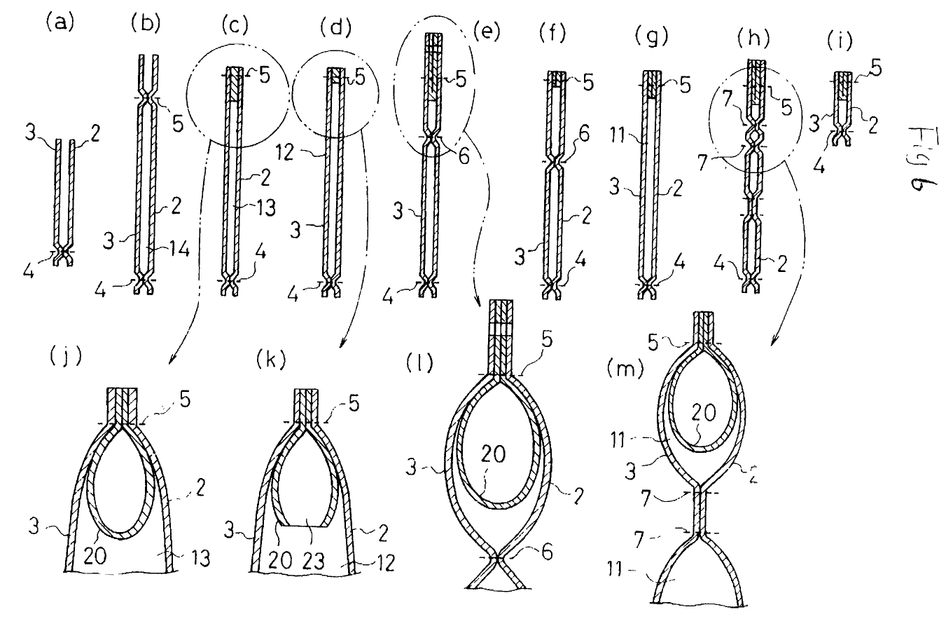

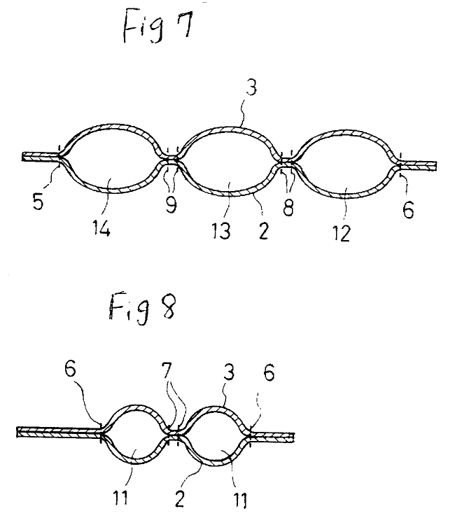

The embodiments of the present invention will be described with reference to the drawings below. FIG. 1 is a front view showing a protecting bag 40 for the head of an automobile occupant according to a first embodiment.

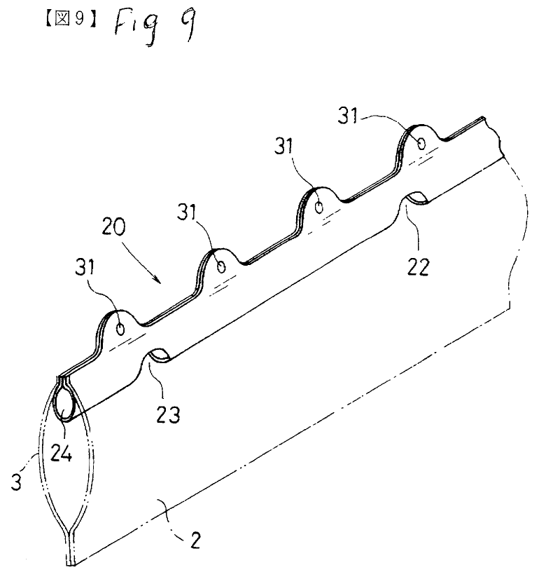

In the bag 40, just like the above described protecting bag 1 shown in FIGS. 5 to 9, cells 66 to 74 and 76 to 80 are formed between both sheets by layering the inside sheet in the occupant side and the outside sheet opposite that (the door side) so as to stitch both the sheets together (numerals 44 to 65 denote seams).

The seam 44 extends along the upper fringe of the bag 40 from the rear end 40R of the bag 40 toward the vicinity of the front end 40F.

The seam 45 extends at a predetermined distance in the side lower than the seam 44 from the rear end 40R of the bag 40 toward the front end 40F so as to form the slender cell 78 between the seam 45 and the seam 44.

The seam 45 changes direction downwardly, shown as seam 45a in FIG. 1, to each vicinity of the lower fringe of the bag 40. Next, seam 45b extends along the lower fringe toward the front end 40F of the bag 40. Seam 45c changes the direction upwardly so as to reach the lower side of the seam 44. Of the seam 45, two vertical seam portions 45a and 45c and one seam portion 45b extending along the lower fringe of the bag 40 form the rear seat cell 76.

The seam 45 approaching the under side of the seam 44 extends along the seam 44 toward the front end 40F of the bag 40. By the seam 44 extending in parallel with the seam 45d and the seam 55, the general horizontally aligned middle cell 79 is formed for communicating the cell 76 for a rear seat with the cell 77 for a front seat.

The seam 45d extends forwardly in parallel with the seam 44. Seam 45e changes the direction downwardly so as to approach the vicinity of the lower fringe of the bag 40. Seam 45f extends along the lower fringe toward the front end 40F of the bag 40. Seam 45g changes the direction upwardly so as to approach the under side of the seam 44. The front seat cell 77 is formed by the seams 45e, 45f, and 45g.

The seam 45 approaching the under side of the seam 44 (45g) extends in substantially parallel with the seam 44 toward the front end 40F of the bag 40 (seam 45h) so as to be connected to the seam 44 by changing the direction to have a U-shape when approaching the vicinity of the front end 40F of the bag 40. In addition, the slender cell 80 is formed of these seams 44 and 45h.

In an upper portion within the bag 40, a tubular body 81 is arranged. The tubular body 81 is arranged, just like the above-described protecting bag 1, by rolling up a long belt-shaped sheet so that the rolled up line faces downwardly. The tubular body 81 is stitched to the bag 40 with the seam 44.

The rear end 82 of the tubular body 81 approaches the rear end 40R of the bag 40 while the closed front end 83 approaches the upper side of the front seat cell 77. In intermediate portions of the tubular body 81, an opening 84 facing the rear seat cell 76 and an opening 85 facing the front seat cell 77 are arranged. To the rear end 82, An inflator (not shown) is connected to the rear end 82.

In the embodiment of FIG. 1, the diameter of the opening 84, which is located nearer to the inflator than the opening 85 is, is smaller than that of the opening 85, which is located further from the inflator than the opening 84 is, enabling gas to be uniformly supplied to the cell 77 for a front seat and the cell 76 for a rear seat.

The seams 46, 47, 48, and 49 extend vertically or obliquely in order to divide the rear seat cell 76 into the cells 66, 67, 68, and 69. At upper ends of the seams 46, 47, 48, and 49, annular seams 56, 57, 58, and 59 are respectively arranged for relieving concentrated stress applied thereto during spreading of the bag 40. Also, at lower ends of the seams 46, 47, 48, and 49, each seam bifurcates so as to meet the seam 45.

In addition, openings at upper ends of the cells 66, 67, 68, and 69 are located at the same distance from the opening 84 of the tubular body 81, and the cells 66, 67, 68, and 69 are radially arranged about the opening 84 of the tubular body 81 as a center.

The seams 50, 51, 52, 53, 54, and 55 divide the front seat cell 77 into the cells 70, 71, 72, 73, and 74. At upper ends of the seams 50, 51, 52, 53, 54, and 55, annular seams 60, 61, 62, 63, 64, and 65 are respectively arranged for relieving concentrated stress applied thereto during inflation of the bag 40. Also, at lower ends of the seams 50, 51, 52, 53, 54, and 55, each seam bifurcates or divides to meet the seam 45.

In addition, openings at upper ends of the cells 70, 71, 72, 73, and 74 are located at approximately the same distance from the opening 85 of the tubular body 81, and the cells 70, 71, 72, 73, and 74 are radially arranged about the opening 85 of the tubular body 81 as a center.

The bag 40 also comprises plural extending portions 30 protruding upwardly, and a small hole 31 is formed in each extending portion 30. By inserting a bolt or rivet into each small hole 31, the bag 40 is fixed to an automobile body.

In the bag 40, the rear end 40R is arranged at a C pillar of an automobile while the front end 40F is arranged at an A pillar, for example. The bag 40 is folded and arranged along a roof-side rail. As described above, the rear end 82 of the tubular body 81 is connected to the inflator.

The folded bag 40 is covered with a cover. The cover is formed so as to tear or to be opened into a cabin when the bag 40 is inflated. The cover may be a cover used exclusively for the protecting bag apparatus or may be a garnish or decorative cover in an automobile cabin.

In the protecting bag 40 constructed in such a manner, when an automobile is in a collision or rolls over, the inflator is operated so that gas flows into the tubular body 81 from the rear end 82 of the tubular body. Part of the gas flowing through the tubular body 81 flows out of the opening 84 so as to inflate the cells 66, 67, 68, and 69 in the rear seat cell 76, while the remaining gas flows out of the opening 85 so as to inflate the cells 70, 71, 72, 73, and 74 in the front seat cell 77 and the cell 80. The inflated rear seat cell 76 extends toward the side of the head of an occupant in the rear seat while the inflated cell 77 for a front seat extends toward the side of the head of an occupant in the front seat.

In the protecting bag 40, the cells 66, 67, 68, and 69 are located at approximately the same distance from the opening 84 of the tubular body 81, so that each cell starts to inflate and completes inflation substantially simultaneously. Since these cells are radially arranged about the opening 84 of the tubular body 81 as a center, the ventilation resistance of gas is small so that each cell inflates smoothly.

Similarly, the cells 70, 71, 72, 73, and 74 are located at approximately the same distance from the opening 85, so that each cell starts to inflate and completes the inflation substantially simultaneously. These cells are radially arranged about the opening 85 as a center, thereby inflating the cells smoothly.

Also, the diameters of two openings 84 and 85 are properly set so as to uniformly supply gas from the openings 84 and 85 of the tubular body 81, so that the cells 66, 67, 68, and 69 in the cell 76 for a rear seat and the cells 70, 71, 72, 73, and 74 in the cell 77 for a front seat start and complete the inflation simultaneously.

In addition, in the embodiment shown in FIG. 1, the cells themselves are radially positioned about one of the openings 84 and 85 of the tubular body 81 as centers. Even when the cells themselves are not radially arranged, each cell starts inflation simultaneously and completes the inflation substantially simultaneously as long as gas inlets of the cells face one of the openings 84 and 85 of the tubular body 81 radially.

FIGS. 2 and 3 are front views of protecting bags 40A and 40B according to a second and a third embodiment of the present invention, respectively.

In the bag 40A shown in FIG. 2, a seam 51A dividing the front seat cell 77 for a front seat extends upwardly higher than the seam 51 of the bag 40 shown in FIG. 1. At the upper end of the seam 51A, an annular seam 61A is arranged.

The seams 50 and 60, which are arranged in the bag 40 shown in FIG. 1, are not provided in the bag 40A shown in FIG. 2.

Similarly, in the bag 40B shown in FIG. 3, a seam 51B dividing the front seat cell 77 also extends upwardly higher than the seam 51 of the bag 40 shown in FIG. 1, and at the upper end thereof, an annular seam 61B is arranged. The seams 50 and 60, which are arranged in the bag 40 shown in FIG. 1, are not provided in the bag 40B shown in FIG. 3. A seam 53B also extends upwardly higher than the seam 53 of the bag 40 shown in FIG. 1, and at the upper end thereof, an annular seam 63B is arranged. Furthermore, a seam 47B dividing the rear seat cell 76 of the bag 40B also extends upwardly higher than the seam 47 of the bag 40 shown in FIG. 1, and at the upper end thereof, an annular seam 57B is arranged.

Other structures of the protecting bags 40A and 40B respectively shown in FIGS. 2 and 3 are the same as those of the protecting bag 40 shown in FIG. 1, and like reference characters in FIGS. 2 and 3 designate like portions in FIG. 1.

In the bag 40A shown in FIG. 2, the seam 51A is arranged at a position upper than other seams 52, 53, 54, and 55 within the front seat cell 77, so that part of gas supplied to the cell 70 from the opening 85 is intercepted. Consequently, the inflation of the cell 70, which is located at the furthest point in the front seat cell 77 from the head of an occupant in a front seat, is retarded while the inflation of the other cells 71, 72, 73, and 74 in the cell 77 for a front seat is advanced.

In the bag 40B shown in FIG. 3, the seams 51B and 53B are arranged in upper positions, so that part of gas supplied to the longitudinal direction of an automobile from the opening 85 is intercepted, facilitating gas to flow downwardly. Consequently, the inflation of the cells 71 and 72, which are located at the nearest portions in the front seat cell 77 to the head of an occupant in a front seat, is advanced ahead the inflation of the other cells 70, 73, and 74. Also, in the cell 76 for a rear seat, the seam 47B extends in a portion upper than other seams 46, 48, and 49 in the cell 76 for a rear seat, so that part of gas flowing into the cells 68 and 69 from the opening 84 is intercepted by the seam 47B, thereby the inflation of the cells 66 and 67 nearest in the rear seat cell 76 to the head of an occupant in a rear seat is advanced.

FIG. 4(a) is a front view of a protecting bag 90 according to a fourth embodiment before inflation and FIG. 4(b) is a front view thereof after inflation.

In the bag 90, cells 111a to 118 are formed between two sheets by layering the inside sheet in the occupant side and the outside sheet opposite the inside sheet so as to stitch (numerals 91 to 105d denote seams) both the sheets together.

The seam 91 extends along the upper fringe of the bag 90 from the rear end 90R of the bag 90 toward the vicinity of the front end 90F.

The seam 92 extends along the lower side of the seam 91 from the rear end 90R of the bag 90 toward the front end 90F at a predetermined distance. Seam 92 extends along the lower fringe of the bag 90 so as to reach the front end 90F. In addition, the seam 92 curves upwardly seven times so as to form cells 111, 112, 113, 114, 115, 116, 117, and 118 until it reaches the front end 90F passing along the lower fringe of the bag 90. The seam 92 curves to have a u-shape at the front end 90F of the bag 90 so as to connect to the seam 91.

The cell 111 is divided into cells 111a and 111b by the seam 93. At the upper end of the seam 93, an annular seam 98 is arranged and the lower end of the seam 93 meets the seam 92.

The cell 114 is divided into cells 114a, 114b, 114c, and 114d by the seams 94, 95, 96, and 97. At upper ends of the seams 94, 95, 96, and 97, annular seams 99, 100, 101, and 102 are arranged, respectively, and the lower ends thereof meet the seam 92. In addition, in the boundary between hollow seams 113 and 114, an inverse triangular seam 103 for preventing excessive inflation toward occupants of the bag 90 is provided.

In an upper portion of the protecting bag 90, a tubular body 120 is arranged so as to be sandwiched by the inside and outside sheets. In intermediate portions of the tubular body 120, an opening 121 facing cells 111a, 111b, 112, 113, and 114a and an opening 122 facing cells 114a, 114b, 114c, and 114d is formed. At the front end of the tubular body, an opening 123 facing cells 115, 116, 117, and 118 is provided.

Around the opening 121 of the tubular body 120, substantially crescent-shaped tentative or temporary seams 103a, 103b, 103c, 103d, and 103e are provided.

Similarly, around the opening 122 of the tubular body, substantially crescent-shaped tentative seams 104a, 104b, 104c, 104d, 104e, and 104f are formed, and around the opening 123 of the tubular body, substantially crescent-shaped tentative seams 105a, 105b, 105c, and 105d are arranged.

In the protecting bag 90 constructed in such a manner, when gas flows out of the openings 121, 122, and 123 of the tubular body 120, the gas is once blocked or intercepted by the tentative seams 103a to 103e, 104a to 104f, and 105a to 105d so as to be suppressed. The tentative seams 103a to 103e, 104a to 104f, and 105a to 105d are torn (see FIG. 4(b)) by gas pressure, so that the gas flows into the cells 111a, 111b, 112, 113, 114a to 114d, 115, 116, 117, and 118. Thereby, the gas does not flow into each cell directly, so that excessive stress is prevented from applying to seams 92, 93, 94, 95, 96, 97, and 103 in the outer periphery of each cell.

As described above, according to the present invention, the arrangement of a gas inlet of each cell in a protecting bag at the same distance from an opening of a tubular body enables each cell to be inflated simultaneously. The radial arrangement of each cell about the opening of the tubular body as a center also enables each cell to be smoothly inflated with a small ventilation resistance. Furthermore, by providing tentative or temporary seams around the opening of the tubular body, gas can be injected into each cell at a moderate and suitable speed. In addition, by changing the distance between the opening of the tubular body and the gas inlet of each cell, each cell can be inflated with a predetermined time difference.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A bag for protecting the heads of occupants of an automobile, the bag configured to be positioned in the vicinity of an intersecting corner line between a ceiling and a side wall in an automobile cabin and to be inflated by introduced gas to expand downwardly along the side wall of the cabin, the protecting bag comprising:
an inside sheet located on the occupant side of the bag;
an outside sheet positioned opposite the inside sheet and located adjacent a window in a side door of the vehicle;
a plurality of cells located between the inside and the outside sheets, each cell configured to be filled with gas and positioned along the longitudinal direction of the automobile;
a tubular gas passage arranged in an upper portion of the bag and extending in the longitudinal direction of the automobile; and
a plurality of gas openings formed in the gas passage at intervals in the longitudinal direction of the gas passage,
wherein the bag is configured so that gas flowing out of the gas openings is supplied to each of the plurality of cells, and
wherein gas inlets of the plurality of cells are arranged at substantially the same distance from at least one of the plurality of openings.

2. The protecting bag of claim 1, wherein the plurality of cells extend from one of the plurality of gas openings in substantially radial directions.

3. The protecting bag of claim 1, further comprising a joining portion which joins the inside sheet and the outside sheet and which is arranged between the gas opening and the gas inlet of the cell, wherein the joining portion is released by gas injected from the opening.

4. The protecting bag of claim 1, wherein the plurality of cells are divided by at least one seam positioned so that the cells located in the vicinity of the head of an occupant inflate prior to the other of the plurality of cells.
